(19) United States
(12) Patent Application Publication
(10) Pub. No.: US 2026/0120085 A1
(43) Pub. Date: Apr. 30, 2026

(54) SYSTEMS AND METHODS FOR EFFICIENT TOKEN BALANCE DETERMINATION

(71) Applicant: CHAINSTACK PTE. LTD., Singapore (SG)

(72) Inventors: Aleksandr KOVAL, Rovinka (SK); Evgeny A. ASEEV, Singapore (SG)

(21) Appl. No.: 18/931,539

(22) Filed: Oct. 30, 2024

(51) Int. Cl. G06Q 20/36

(52) U.S. Cl. CPC G06Q 20/3676

(57) ABSTRACT

A system receives a user request for a balance of a wallet at a wallet address. The system identifies smart contracts in an in-memory database associated with the wallet address by: navigating a Bloom filter trie comprising a plurality of nodes, wherein each respective node includes a respective Bloom filter that indicates whether a token is present in a token set represented by the respective Bloom filter, retrieving, from the Bloom filter trie, contract addresses of the smart contracts associated with tokens in the wallet at the wallet address. The system makes a call to each of the smart contracts using the contract addresses to determine individual token balances. The system combines, to yield the balance of the wallet, the individual token balances received from the smart contracts. The system outputs, in response to the user request, the balance of the wallet on a user interface.

### FIELD OF TECHNOLOGY

The present disclosure relates to the field of blockchain networks, and, more specifically, to systems and methods for efficient token balance determination.

### BACKGROUND

Acquiring token balances on Ethereum Virtual Machine (EVM) blockchains (e.g., Ethereum) is a common action that can significantly impact the performance of the associated blockchain network. Firstly, EVM blockchains are decentralized and distributed systems. Every node in the network maintains a copy of the entire ledger. This means that to get a token balance, the query has to interact with the blockchain. The EVM blockchain utilizes complex data structures to store and manage data. The data structure for storing balances is not straightforward, and retrieving information from it may be resource-intensive and time-consuming, especially when dealing with large datasets or multiple queries.

Furthermore, tokens on EVM blockchains are often managed through smart contracts, which are programs stored on the blockchain. To retrieve a token balance, the smart contract must be executed to read the balance from its storage. This process requires additional computational resources and time.

As the number of transactions and smart contracts on the blockchain increases, the data becomes more extensive and complex. This growth impacts the speed and efficiency of querying token balances, leading to scalability and performance issues.

### SUMMARY

In one exemplary aspect, the techniques described herein relate to a method for efficient data retrieval in a blockchain, the method including: receiving a user request for a balance of a wallet at a wallet address; identifying smart contracts in an in-memory database associated with the wallet address by: navigating a Bloom filter trie including a plurality of nodes, wherein each respective node includes a respective Bloom filter that indicates whether a token is present in a token set represented by the respective Bloom filter; retrieving, from the Bloom filter trie, contract addresses of the smart contracts associated with tokens in the wallet at the wallet address; making a call to each of the smart contracts using the contract addresses to determine individual token balances; combining, to yield the balance of the wallet, the individual token balances received from the smart contracts; outputting, in response to the user request, the balance of the wallet on a user interface.

In some aspects, the techniques described herein relate to a method, wherein making the call includes: making a single read-only call to a multi-call contract, which is further configured to make a call to each of the smart contracts at the contract addresses and return a batch response.

In some aspects, the techniques described herein relate to a method, wherein the Bloom filter trie includes a plurality of Bloom filters representing a variety of token types.

In some aspects, the techniques described herein relate to a method, wherein the smart contracts are ERC-20 contracts.

In some aspects, the techniques described herein relate to a method, wherein the in-memory database is Redis.

In some aspects, the techniques described herein relate to a method, wherein the smart contracts are further configured to request the individual token balances from a node state of a full state node in a blockchain network.

In some aspects, the techniques described herein relate to a method, further including generating the Bloom filter trie by: retrieving a last synchronization state of a blockchain from the in-memory database; fetching logs for a subsequent block interval; identifying, using the logs, relations between addresses and smart contracts; saving the relations in the in-memory database; and generating the Bloom filter trie to represent all relations stored in the in-memory database.

It should be noted that the methods described above may be implemented in a system comprising a hardware processor. Alternatively, the methods may be implemented using computer executable instructions of a non-transitory computer readable medium.

In some aspects, the techniques described herein relate to a system for efficient data retrieval in a blockchain, including: at least one memory; at least one hardware processor coupled with the at least one memory and configured, individually or in combination, to: receive a user request for a balance of a wallet at a wallet address; identify smart contracts in an in-memory database associated with the wallet address by: navigating a Bloom filter trie including a plurality of nodes, wherein each respective node includes a respective Bloom filter that indicates whether a token is present in a token set represented by the respective Bloom filter; retrieving, from the Bloom filter trie, contract addresses of the smart contracts associated with tokens in the wallet at the wallet address; make a call to each of the smart contracts using the contract addresses to determine individual token balances; combine, to yield the balance of the wallet, the individual token balances received from the smart contracts; output, in response to the user request, the balance of the wallet on a user interface.

In some aspects, the techniques described herein relate to a non-transitory computer readable medium storing thereon computer executable instructions for efficient data retrieval in a blockchain, including instructions for: receiving a user request for a balance of a wallet at a wallet address; identifying smart contracts in an in-memory database associated with the wallet address by: navigating a Bloom filter trie including a plurality of nodes, wherein each respective node includes a respective Bloom filter that indicates whether a token is present in a token set represented by the respective Bloom filter; retrieving, from the Bloom filter trie, contract addresses of the smart contracts associated with tokens in the wallet at the wallet address; making a call to each of the smart contracts using the contract addresses to determine individual token balances; combining, to yield the balance of the wallet, the individual token balances received from the smart contracts; outputting, in response to the user request, the balance of the wallet on a user interface.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for efficient token balance determination.

FIG. 2 is a block diagram illustrating an upper level architecture of the system.

FIG. 3 is a block diagram illustrating a method for saving address-to-address relations.

FIG. 4 is a block diagram illustrating a method for token balance determination.

FIG. 5 is a block diagram illustrating a Bloom filter trie.

FIG. 6 illustrates a flow diagram of a method for efficient token balance determination.

FIG. 7 presents an example of a general-purpose computer system on which aspects of the present disclosure may be implemented.

### DETAILED DESCRIPTION

Exemplary aspects are described herein in the context of a system, method, and computer program product for efficient token balance determination. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

To address the aforementioned shortcomings, this disclosure introduces the use of a Bloom filter to determine token balances. Specifically, a Bloom Filter trie (prefix tree) is employed to index all relationships between contracts. This approach enables rapid searching and achieves a high rate of requests per second (RPS) for all tokens that a contract interacts with, while also minimizing memory usage for storing contract relationships. By utilizing an indexed list, interactions with blockchain nodes can effectively handle issues related to blockchain dead branches (rollbacks) and balance state storage. Consequently, users can request and obtain the balance for a specific block efficiently.

For example, consider a scenario where a user wants to know the token balance of a particular contract at a specific block height. The Bloom Filter trie allows for quick identification of all relevant contract interactions, ensuring that the balance may be retrieved swiftly without excessive memory consumption. Additionally, in the event of a blockchain reorganization (rollback), the indexed relationships help maintain accurate balance information, preventing data inconsistencies.

Conventional balance retrieval schemes utilize state caching. When utilizing state caching from a node, it becomes imperative to reindex the cache in the event of a blockchain reorganization (reorg). Any alterations in the EVM state have the potential to invalidate the cached data (index). This presents a significant challenge, as it necessitates continuous monitoring to ensure data integrity. Failure to properly reindex and monitor the cache can result in data loss, which equates to corrupted or broken data. The solution of the present disclosure does not store any state cache. Instead, the solution comprises maintaining only relational data. An optimized method is then employed to retrieve data from the blockchain, considering that 90% of addresses hold up to 20 tokens.

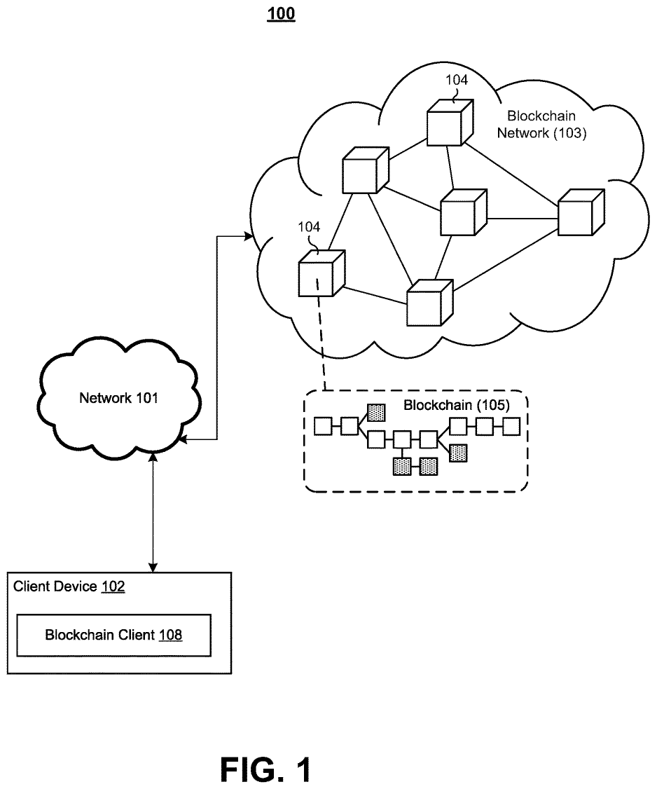

FIG. 1 is a block diagram illustrating system 100 comprising a blockchain network. According to an exemplary aspect, the blockchain network 103 may be a distributed peer-to-peer network formed from a plurality of nodes 104 (computing devices) that collectively maintain a distributed ledger, also referred to as a blockchain 105. The blockchain 105 is a continuously-growing list of data records hardened against tampering and revision using cryptography and is composed of data structure blocks that hold the data received from other nodes 104 or other client nodes, including the client device 102 and server systems executing an instance of the blockchain client 108. The blockchain client 108 is configured to transmit, over network 101 (e.g., the Internet) data values to the blockchain network 103 as a transaction data structure, and the nodes 104 in the blockchain network 103 record and validate/confirm when and in what sequence the data transactions enter and are logged in the existing blockchain 105.

In some aspects, there might be a connection between all nodes (e.g., in the case of traditional blockchains like Ethereum), or between selected nodes and network service (e.g., in the case of R3 Corda where nodes talk to a network map service to discover each other and talk to each other directly to transact without broadcasting all the transactions to all nodes in the network).

A distributed ledger is a consensus of replicated, shared, and synchronized digital data geographically spread across multiple entities. In DLT, the distributed ledger database is spread across several nodes on a peer-to-peer network, where each node replicates and saves an identical copy of the ledger and updates itself independently. A blockchain is a form of DLT. A directed acyclic graph (DAG) is another form of DLT. In some aspects, DLTs may be permissioned or permission-less. In a permissioned DLT, users are not freely able to join the network, see recorded history, and record their own transactions. In a permission-less DLT, virtually any user can interact with a network by recording transactions and adding entries to the ledger.

The transaction data structure may include computer-executable code, or a reference to computer-executable code stored in an existing blockchain entry, that is executed by a node 104 in the blockchain network 103 as part of the validation procedure. In some aspects, every node in the decentralized system can have a copy of the growing blockchain 105, avoiding the need to have a centralized ledger managed by a trusted third party. It should be noted that this does not apply to broader distributed ledger technology such as Hyperledger Fabric and R3 Corda. Nonetheless, the methods and various features of the present disclosure are applicable to the broader distributed ledger technology.

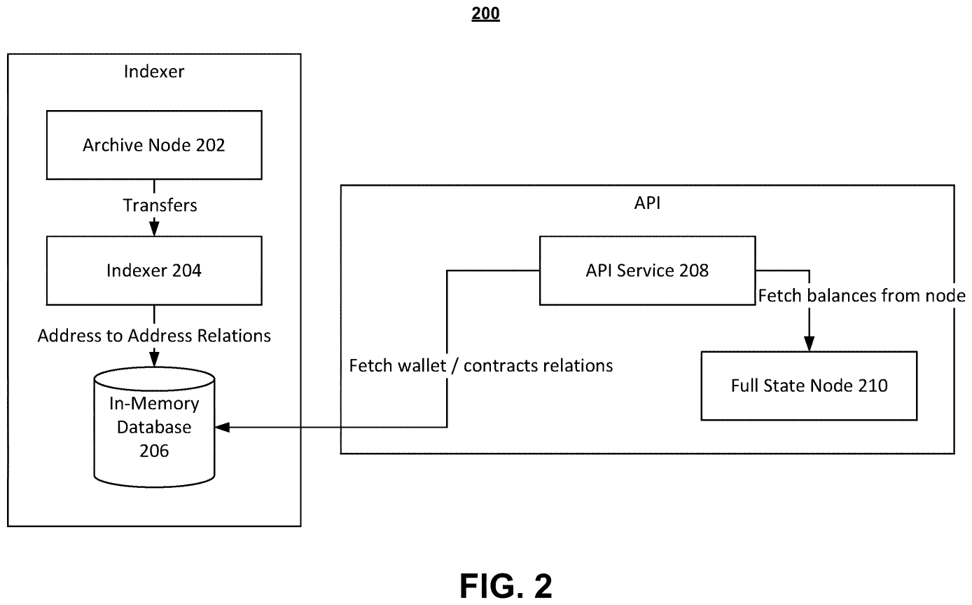

FIG. 2 is a block diagram illustrating the upper-level architecture 200 of the system 100, which is divided into two main components: the indexer and the API. The indexer component begins with archive node 202, which is responsible for storing the complete history of the blockchain (e.g., blockchain 105), including all transactions and states. Node 202 transfers data to indexer 204, which processes the data to establish address-to-address relationships. For example, if Address A sends tokens to Address B, this relationship is indexed.

In an exemplary aspect, a Bloom Filter trie is employed to index all relationships between contracts. The Bloom Filter trie combines the probabilistic nature of Bloom filters with the hierarchical structure of a trie, allowing for compact and efficient storage of relational data. A trie is a specialized type of tree used primarily for storing strings. Each node in a trie represents a single character of a string, and the path from the root to a node represents a prefix of the stored strings.

Consider a scenario where multiple addresses interact with an ERC-20 token contract. Each transaction, whether it is a token transfer, approval, or contract call, is captured and indexed by indexer 204. The Bloom Filter trie is particularly effective in this context because it can handle the high volume of interactions without significant memory overhead. For instance, if Address C approves Address D to spend tokens on its behalf, this approval is indexed by indexer 204, which uses the Bloom Filter trie for indexing relationships. The relationships indexed using the Bloom Filter trie are then stored in In-memory database 206 (e.g., Redis), which is a high-performance in-memory data structure store, allowing for quick retrieval of relational data.

The API component includes the API service 208, which interacts with In-memory database 206 to fetch the pre-indexed wallet/contract relationships. For instance, if a user wants to know all the contracts a particular wallet has interacted with, the API service retrieves this information from the Bloom Filter trie in In-memory database 206. Additionally, the API service 208 communicates with a full state node 210 to fetch the current balances of the addresses. A full state node 210 includes the latest state of the blockchain, ensuring that the balance information is up-to-date.

For example, when a user requests the balance of a specific wallet, the API service 208 first queries In-memory database 206 to get all the contracts and addresses that the wallet has interacted with. When a query is made, In-memory database 206 may access the relevant Bloom filters, enabling rapid searches through the Bloom filter trie. For instance, if the system needs to verify whether a specific address has interacted with any contracts, In-memory database 206 can retrieve the necessary Bloom filters from the trie and perform the search operation. Each node in the trie may include a Bloom filter that helps in quickly determining if a token is part of the subset represented by that node. If a given Bloom filter indicates that the token is not part of the subset, a different Bloom filter is accessed. When the Bloom filter indicates that the token is part of its set, the contract address associated with the token is retrieved.

API service 208 then queries the full state node 210 to get the current balance associated with said address. In the context of the present disclosure, full state node 210 in a blockchain network 103 maintains the complete state of the blockchain 105, including all account balances and contract states.

Finally, the API service 208 compiles this data and provides the requested balance information to the user. This architecture ensures efficient data retrieval and accurate balance information by leveraging the strengths of both the indexer and the API components.

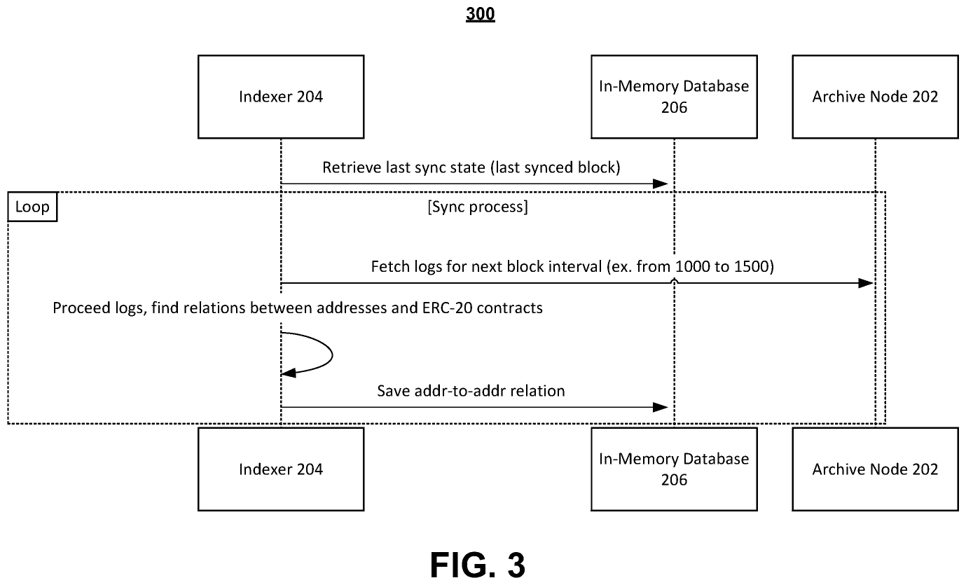

FIG. 3 is a block diagram illustrating method 300 for saving address-to-address relations. The process begins with the indexer 204 retrieving the last sync state, which is the last synced block of the blockchain, from In-memory database 206. For example, if the last synced block is 999, the indexer 204 will start processing from block 1000. The synchronization process involves a loop where the indexer 204 fetches logs for the next block interval, such as from block 1000 to block 1500, from the archive node 202. In some aspects, this interval can be adjusted based on the system's performance and the volume of transactions.

Once the logs are fetched, indexer 204 processes these logs to identify relationships between addresses and ERC-20 contracts. For instance, if Address A transfers tokens to Address B within this block range, the indexer 204 will record this interaction. Similarly, if Address C interacts with an ERC-20 contract to approve a token transfer, this relationship is also noted. In an exemplary aspect, indexer 204 scans through each log entry to ensure that all relevant address-to-address interactions are captured.

Based on this processing, indexer 204 saves the identified address-to-address relations in In-memory database 206. In particular, a Bloom filter trie is generated to represent these relations. This storage in In-memory database 206 allows for quick and efficient retrieval of relational data. For example, if a user later queries API service 208 to find all addresses that have interacted with a specific ERC-20 contract, API service 208 can quickly provide this information from Redis.

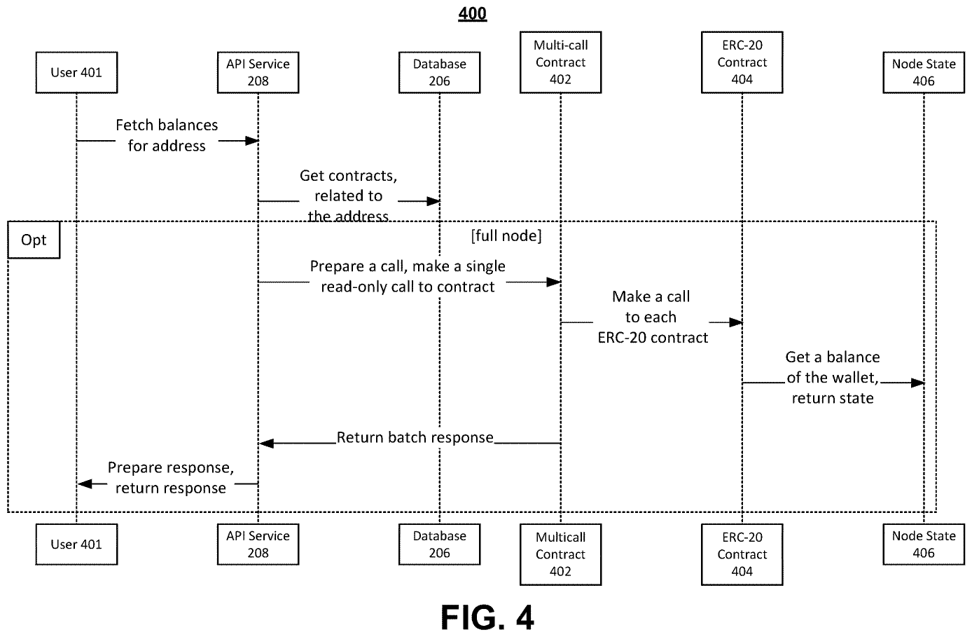

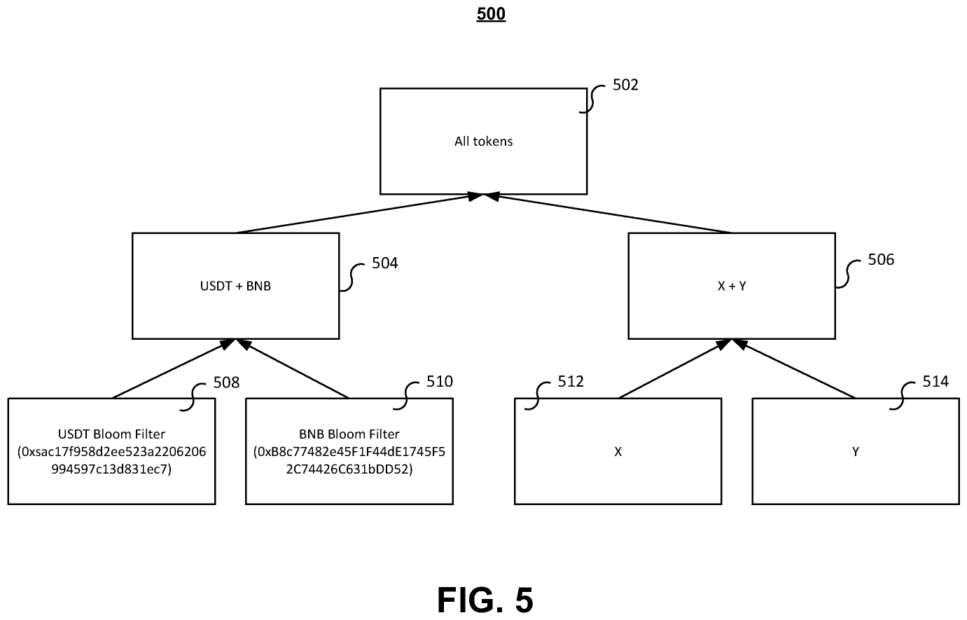

FIG. 4 is a block diagram illustrating method 400 for token balance determination. In method 400, a user 401 initiates a request for the balance of a particular address by contacting the API service 208. For example, the user might want to know the balance of their wallet address “0x1234 . . . ABCD.” Upon receiving this request, API service 208 retrieves any contracts related to the specified address from In-memory database 206 using a Bloom filter trie (described in FIG. 5).

In response to identifying one or more contracts associated with the address using the Bloom filter trie, API service 208 uses a multi-call contract 402 to retrieve balance information. In particular, a multi-call contract is a smart contract designed to aggregate multiple read-only calls into a single call, thereby optimizing the process. API service 208 prepares and makes a single read-only call to the multi-call contract 402, which in turn, makes individual calls to each ERC-20 contract associated with the address. For instance, if the address holds tokens from ERC-20 contracts like “TokenA” and “TokenB,” multi-call contract 402 will query both of these contracts.

Each ERC-20 contract, such as ERC-contract 404, retrieves the balance of the wallet from a full state node 210 with node state 406. Node state 406 may include the most up-to-date information about the blockchain 105, including all token balances. For example, the ERC-contracts may find that the wallet holds 100 “TokenA” tokens and 50 “TokenB” tokens. Once all the individual balances are retrieved, the multi-call contract 402 compiles this information into a batch response.

This batch response is then provided by multi-call contract 402 to API service 208. API service 208 processes this batch response, preparing a comprehensive balance report for the user 401. For instance, the final response may be generated on a graphical user interface and may indicate that the user's wallet holds 100 “TokenA” tokens and 50 “TokenB” tokens. API service 208 returns this detailed balance information to user 401, ensuring that the user receives accurate and timely data regarding their token holdings.

FIG. 5 is a block diagram illustrating a Bloom filter trie 500. The Bloom filter trie 500 includes a parent node 502, which has child nodes 504 and 506. The parent node 502 represents the aggregate set of all tokens. Child node 504 represents the Bloom filter of the combined set of Tether (USDT) and Binance (BNB) tokens, while child node 506 represents the Bloom filter of the combined set of tokens X and Y. The child nodes of node 504 are nodes 508 and 510. Node 508 includes the Bloom Filter for USDT token (0xdac17f958d2ee523a2206206994597c13d831ec7), and node 510 includes the Bloom Filter for BNB token (0xB8c77482e45F1F44dE1745F52C74426C631bDD52). Similarly, the child nodes of node 506 are nodes 512 and 514, which store the Bloom Filters for tokens X and Y, respectively.

In this structure, each node represents a subset of the overall dataset, with the parent node encompassing the entire set of tokens and each subsequent child node representing more specific subsets. For example, node 504 aggregates the Bloom Filters for USDT and BNB, allowing for efficient membership testing and quick lookups for these specific tokens.

In this example, the string 0xB8c77482e45F1F44dE1745F52C74426C631bDD52 is the Ethereum contract address for the BNB token. In the context of the Bloom filter trie described, this address is used to uniquely identify the BNB token within the trie structure. Specifically, node 510 includes the Bloom filter for BNB, and this address is associated with that node to indicate that it represents the BNB token. Ethereum contract addresses are unique identifiers on the Ethereum blockchain, and they are used to interact with smart contracts and tokens. Similarly, the string 0xdac17f958d2ee523a2206206994597c13d831ec7 represents the Ethereum contract address for the USDT token.

To navigate the Bloom filter trie 500 to access the address for the BNB token (e.g., node 510), the system initiates the traversal at the root node (node 502), which encapsulates the aggregate set of all tokens. From the root node, the system identifies the appropriate child node that includes the subset including the BNB token, specifically child node 504, which represents the Bloom filter with the combined set of USDT and BNB tokens. The system then traverses to child node 504 and further pinpoints the specific child node that includes the Bloom filter for the BNB token, which is node 510. At node 510, the system would access the Bloom filter associated with the BNB token and retrieve the Ethereum contract address ‘0xB8c77482e45F1F44dE1745F52C74426C631bDD52’.

On a more technical level and in reference to FIG. 4, to get the balance of BNB tokens, the multi-call contract 402 may interact with the BNB token's contract (e.g., ERC-20 contract 404) on the Ethereum blockchain. The process begins by using the Bloom filter trie to identify the presence of the BNB token and retrieve its contract address, which is ‘0xB8c77482e45F1F44dE1745F52C74426C631bDD52’. Contract 402 may then interact with contract 404 using the standard ERC-20 interface, specifically calling the ‘balanceOf’ function on the BNB token contract to retrieve the balance of BNB tokens for a given account address. This function retrieves the token balance from the state (e.g., node state 406) of the Ethereum blockchain, which is maintained by full state nodes such as full state node 210.

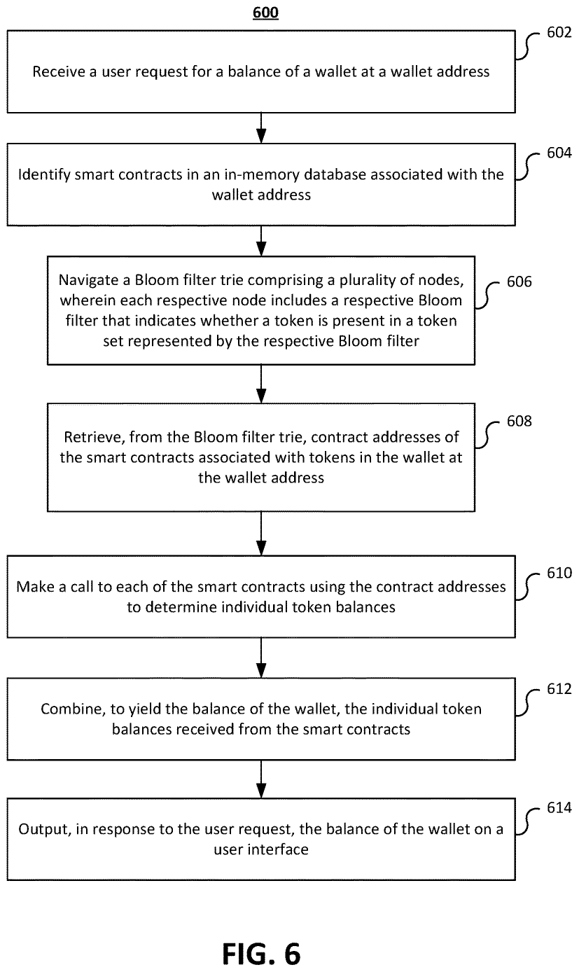

FIG. 6 illustrates a flow diagram of a method 600 for efficient token balance determination. At 602, API service 208 receives a user request for a balance of a wallet at a wallet address.

At 604, API service 208 identifies smart contracts in an in-memory database (e.g., database 206) associated with the wallet address. In some aspects, the smart contracts are ERC-20 contracts (e.g., ERC-contract 404). In some aspects, the in-memory database is Redis.

Step 604 comprises steps 606 and 608. At 606, API service 208 navigates a Bloom filter trie comprising a plurality of nodes, wherein each respective node includes a respective Bloom filter that indicates whether a token is present in a token set represented by the respective Bloom filter. In some aspects, the Bloom filter trie includes a plurality of Bloom filters representing a variety of token types. At 608, API service 208 retrieves, from the Bloom filter trie, contract addresses of the smart contracts associated with tokens in the wallet at the wallet address.

At 610, API service 208 makes a call to each of the smart contracts using the contract addresses to determine individual token balances. In some aspects, this involves making a single read-only call to a multi-call contract, which is further configured to make a call to each of the smart contracts at the contract addresses and return a batch response. In some aspects, the smart contracts are further configured to request the individual token balances from a node state of a full state node in a blockchain network.

At 612, API service 208 combines, to yield the balance of the wallet, the individual token balances received from the smart contracts.

At 614, API service 208 outputs, in response to the user request, the balance of the wallet on a user interface.

In some aspects, indexer 204 generates the Bloom filter trie by: (1) retrieving a last synchronization state of a blockchain from the in-memory database; (2) fetching logs for a subsequent block interval; (3) identifying, using the logs, relations between addresses and smart contracts; (4) saving the relations in the in-memory database; and (5) generating the Bloom filter trie to represent all relations stored in the in-memory database.

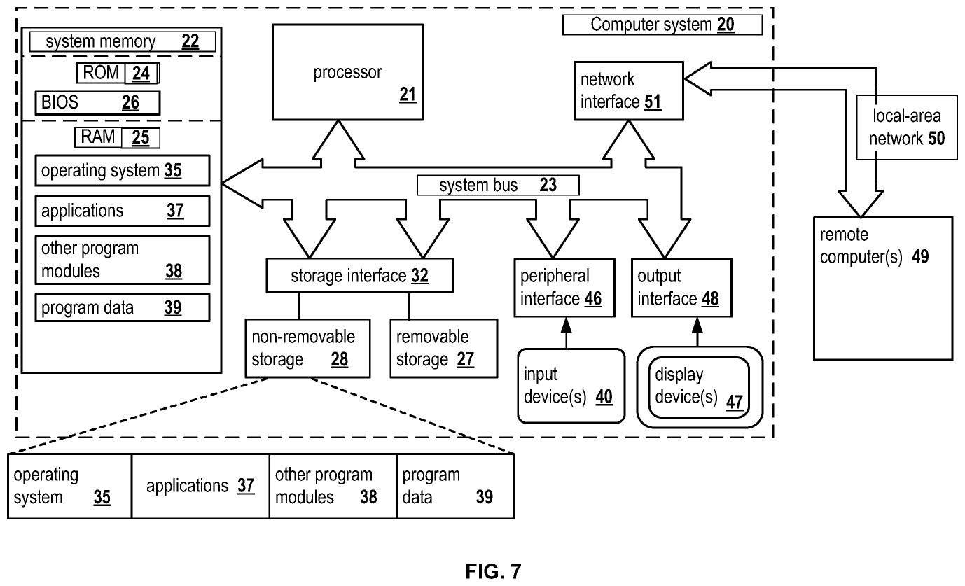

FIG. 7 is a block diagram illustrating a computer system 20 on which aspects of systems and methods for efficient token balance determination may be implemented in accordance with an exemplary aspect. The computer system 20 may be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which may be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium may be a tangible device that can retain and store program code in the form of instructions or data structures that may be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein may be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure may be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for efficient data retrieval in a blockchain, the method comprising:
receiving a user request for a balance of a wallet at a wallet address;
identifying smart contracts in an in-memory database associated with the wallet address by:
navigating a Bloom filter trie comprising a plurality of nodes, wherein each respective node includes a respective Bloom filter that indicates whether a token is present in a token set represented by the respective Bloom filter;
retrieving, from the Bloom filter trie, contract addresses of the smart contracts associated with tokens in the wallet at the wallet address;
making a call to each of the smart contracts using the contract addresses to determine individual token balances, wherein making the call comprises making a single read-only call to a multi-call contract, which is further configured to make a call to each of the smart contracts at the contract addresses and return a batch response;
combining, to yield the balance of the wallet, the individual token balances received from the smart contracts;
outputting, in response to the user request, the balance of the wallet on a user interface.

2. (canceled)

3. The method of claim 1, wherein the Bloom filter trie includes a plurality of Bloom filters representing a variety of token types.

4. The method of claim 1, wherein the smart contracts are ERC-20 contracts.

5. The method of claim 1, wherein the in-memory database is Redis.

6. The method of claim 1, wherein the smart contracts are further configured to request the individual token balances from a node state of a full state node in a blockchain network.

7. The method of claim 1, further comprising generating the Bloom filter trie by:
retrieving a last synchronization state of a blockchain from the in-memory database;
fetching logs for a subsequent block interval;
identifying, using the logs, relations between addresses and smart contracts;
saving the relations in the in-memory database; and
generating the Bloom filter trie to represent all relations stored in the in-memory database.

8. A system for efficient data retrieval in a blockchain, comprising:
at least one memory;
at least one hardware processor coupled with the at least one memory and configured, individually or in combination, to:
receive a user request for a balance of a wallet at a wallet address;
identify smart contracts in an in-memory database associated with the wallet address by:
navigating a Bloom filter trie comprising a plurality of nodes, wherein each respective node includes a respective Bloom filter that indicates whether a token is present in a token set represented by the respective Bloom filter;
retrieving, from the Bloom filter trie, contract addresses of the smart contracts associated with tokens in the wallet at the wallet address;
make a call to each of the smart contracts using the contract addresses to determine individual token balances, wherein making the call comprises making a single read-only call to a multi-call contract, which is further configured to make a call to each of the smart contracts at the contract addresses and return a batch response;
combine, to yield the balance of the wallet, the individual token balances received from the smart contracts;
output, in response to the user request, the balance of the wallet on a user interface.

9. (canceled)

10. The system of claim 8, wherein the Bloom filter trie includes a plurality of Bloom filters representing a variety of token types.

11. The system of claim 8, wherein the smart contracts are ERC-20 contracts.

12. The system of claim 8, wherein the in-memory database is Redis.

13. The system of claim 8, wherein the smart contracts are further configured to request the individual token balances from a node state of a full state node in a blockchain network.

14. The system of claim 8, wherein the at least one hardware processor is configured to generate the Bloom filter trie by:
retrieving a last synchronization state of a blockchain from the in-memory database;
fetching logs for a subsequent block interval;
identifying, using the logs, relations between addresses and smart contracts;
saving the relations in the in-memory database; and
generating the Bloom filter trie to represent all relations stored in the in-memory database.

15. A non-transitory computer readable medium storing thereon computer executable instructions for efficient data retrieval in a blockchain, including instructions for:
receiving a user request for a balance of a wallet at a wallet address;
identifying smart contracts in an in-memory database associated with the wallet address by:
navigating a Bloom filter trie comprising a plurality of nodes, wherein each respective node includes a respective Bloom filter that indicates whether a token is present in a token set represented by the respective Bloom filter;
retrieving, from the Bloom filter trie, contract addresses of the smart contracts associated with tokens in the wallet at the wallet address;
making a call to each of the smart contracts using the contract addresses to determine individual token balances, wherein making the call comprises making a single read-only call to a multi-call contract, which is further configured to make a call to each of the smart contracts at the contract addresses and return a batch response;
combining, to yield the balance of the wallet, the individual token balances received from the smart contracts;
outputting, in response to the user request, the balance of the wallet on a user interface.

16. (canceled)

17. The non-transitory computer readable medium of claim 15, wherein the Bloom filter trie includes a plurality of Bloom filters representing a variety of token types.

18. The non-transitory computer readable medium of claim 15, wherein the smart contracts are ERC-20 contracts.

19. The non-transitory computer readable medium of claim 15, wherein the in-memory database is Redis.

20. The non-transitory computer readable medium of claim 15, wherein the smart contracts are further configured to request the individual token balances from a node state of a full state node in a blockchain network.
